(19) United States
(12) Patent Application Publication
(10) Pub. No.: US 2016/0134011 A1
(43) Pub. Date: May 12, 2016

(54) ANTENNA MODULE AND ANTENNA ASSEMBLY INCLUDING THE SAME

(71) Applicant: Samsung Electro-Mechanics Co., Ltd., Suwon-si (KR)

(72) Inventors: Nam Ki KIM, Suwon-si (KR); Chan Gwang AN, Suwon-si (KR); Dae Ki LIM, Suwon-si (KR); Hyeon Gil NAM, Suwon-si (KR); Sang Woo BAE, Suwon-si (KR); Ha Ryong HONG, Suwon-si (KR); Sung Eun CHO, Suwon-si (KR); Dae Kyu LEE, Suwon-si (KR); Dae Seong JEON, Suwon-si (KR); Hyun Do PARK, Suwon-si (KR)

(73) Assignee: Samsung Electro-Mechanics Co., Ltd., Suwon-si (KR)

(21) Appl. No.: 14/886,677

(22) Filed: Oct. 19, 2015

(30) Foreign Application Priority Data
Nov. 10, 2014 (KR) 10-2014-0155545

(51) Int. Cl. H01Q 1/24; H01Q 13/10; H01Q 1/50

(52) U.S. Cl. CPC H01Q 1/243; H01Q 1/50; H01Q 13/106

(57) ABSTRACT

An antenna module includes: a circuit board including a connector; a metal frame including an antenna pattern part configured to transmit or receive a signal, and a connection terminal part electrically connecting the antenna pattern part and the circuit board to each other; and a molding frame disposed around the metal frame such that the connection terminal part is exposed to one surface of the molding frame, wherein the connector is disposed between the metal frame and the circuit board.

### CROSS-REFERENCE TO RELATED APPLICATION(S)

This application claims the benefit of Korean Patent Application No. 10-2014-0155545 filed on Nov. 10, 2014, in the Korean Intellectual Property Office, the entire disclosure of which is incorporated herein by reference for all purposes.

### BACKGROUND

1. Field

The following description relates to an antenna module and an electronic device including the same.

2. Description of Related Art

Mobile communications terminals such as mobile phones, personal digital assistants (PDAs), navigation systems, laptop computers, and the like, which support wireless communications, continue to be developed, and functions such as code division multiple access (CDMA), wireless LAN, Global System for Mobile Communications (GSM), digital multimedia broadcasting, and the like, have been added. In order to perform the aforementioned functions, the mobile communications terminals include an antenna.

In addition, an embedded antenna has been used in recent times. The embedded antenna is manufactured by integrating the above-mentioned antenna with a mobile communications terminal using an injection-molding method, or the like.

However, as mobile communications terminals have become smaller, they may not have a sufficient space therein for the embedded antenna.

Therefore, it is desirable to reduce the space required for the embedded antenna in mobile communications terminals.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, an antenna module includes: a circuit board including a connector; a metal frame including an antenna pattern part configured to transmit or receive a signal, and a connection terminal part electrically connecting the antenna pattern part and the circuit board to each other; and a molding frame disposed around the metal frame such that the connection terminal part is exposed to one surface of the molding frame, wherein the connector is disposed between the metal frame and the circuit board.

The antenna pattern part may be disposed on an inner side of the molding frame, and the one surface of the molding frame may face the circuit board.

The antenna pattern part may be disposed above the connector, and the connection terminal part may be bent with respect to the antenna pattern part toward the connector.

The connector may be disposed inside a space formed by the antenna pattern part and the connection terminal part.

The antenna pattern part may include a slit.

The slit may include at least one bend.

The antenna pattern part may be exposed to an other surface of the molding frame opposite to the one surface of the molding frame to which the connection terminal part is exposed.

A protective film may be disposed on the other surface of the molding frame and the connection terminal part.

According to another general aspect, an antenna assembly includes: an antenna module including a metal frame including an antenna pattern part and being electrically connected to a circuit board including a connector so as to transmit a signal to the circuit board or receive a signal from the circuit board, and a molding frame disposed around the metal frame; and a cover frame covering an upper outer surface of the antenna module, wherein the connector is disposed between the metal frame and the circuit board, and the antenna pattern part is disposed between the molding frame and the cover frame.

The metal frame may be bent with respect to the antenna pattern part toward the connector.

The connector may be disposed inside a space formed by the antenna pattern part and the connection terminal part.

The antenna pattern part may include a slit.

The cover frame may form a portion of a case of a mobile communications terminal.

According to another general aspect, a circuit board includes: a connector; a metal frame comprising an antenna pattern part configured to transmit or receive a signal, and a connection terminal part electrically connecting the antenna pattern part and the circuit board to each other; and a molding frame disposed around the metal frame, wherein the connector is disposed between the metal frame and the circuit board, and wherein the connection terminal part comprises a reinforcement part protruding from a contact part of the connection terminal part and elastically contacting the circuit board.

The reinforcement part may be bead-shaped.

The connector may be configured to enable charging of the electronic device, and transmitting and receiving data.

Other features and aspects will be apparent from the following detailed description, the drawings, and the claims.

### BRIEF DESCRIPTION OF DRAWINGS

FIG. 1 is a perspective view of an example of an electronic device including an antenna module.

FIG. 2 is an exploded perspective view of the electronic device illustrated in FIG. 1.

FIGS. 3A through 3C are cross-sectional views taken along line A-A′ of FIG. 1 according to various examples.

FIGS. 4A through 4C are perspective views of a metal frame according to various examples.

FIG. 5 is a perspective view of another example of an electronic device including an antenna assembly.

FIG. 6 is an exploded perspective view of the electronic device illustrated in FIG. 5.

FIG. 7 is a cross-sectional view taken along line B-B′ of FIG. 5.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

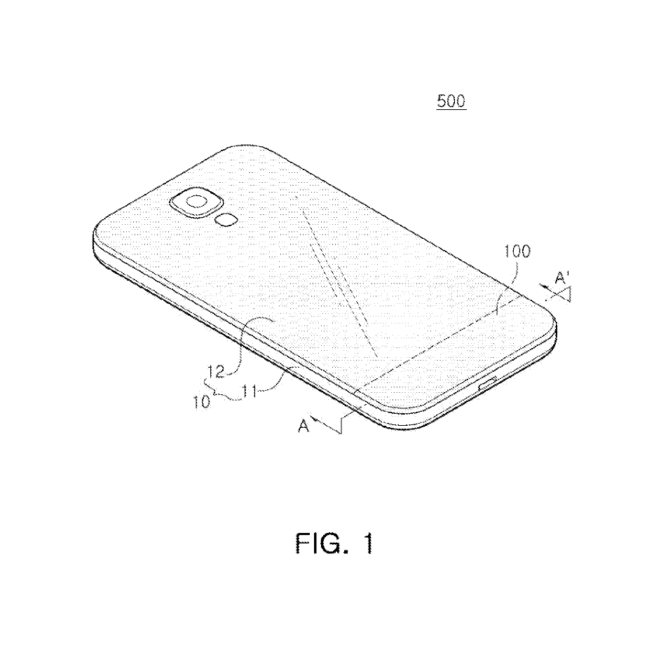

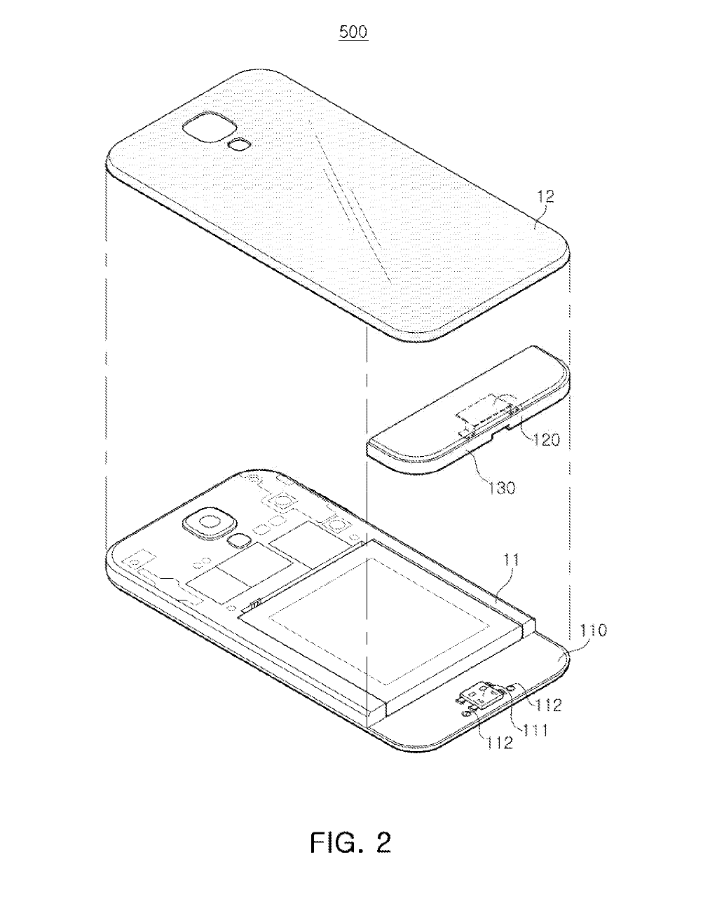

FIG. 1 is a perspective view of an electronic device 500 including an antenna module 100 according to an example, and FIG. 2 is an exploded perspective view of the electronic device 500.

Referring to FIGS. 1 and 2, the electronic device 500 includes a case 10 and an antenna module 100.

The case 10, which may form the exterior of the electronic device 500, includes a body part 11 and a rear cover 12. The body part 11 and the rear cover 12 are coupled to each other to form an internal space, and the internal space may include various electronic elements required to drive the electronic device 500.

In addition, the antenna module 100 to be described below is included within the case 10. The case 10 may prevent the electronic elements and the antenna module 100 from being externally exposed and being damaged due to external shock.

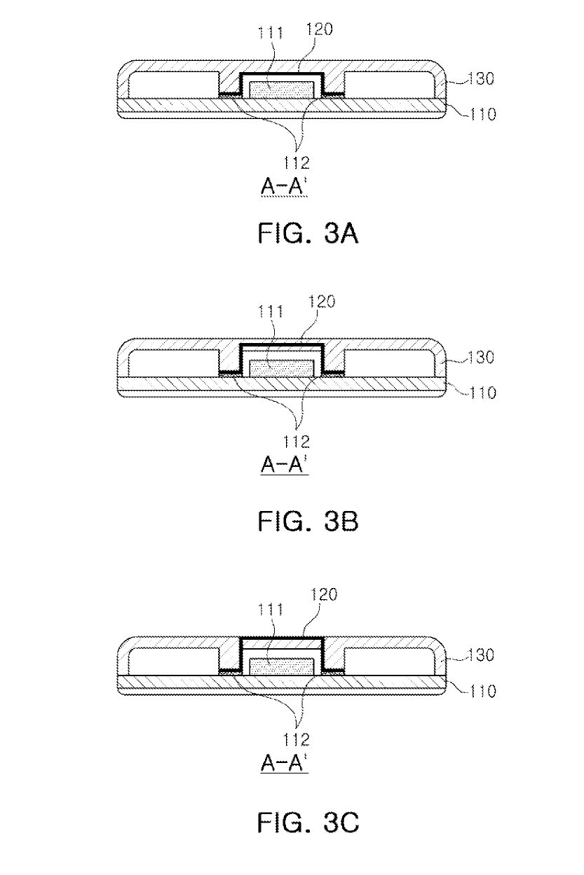

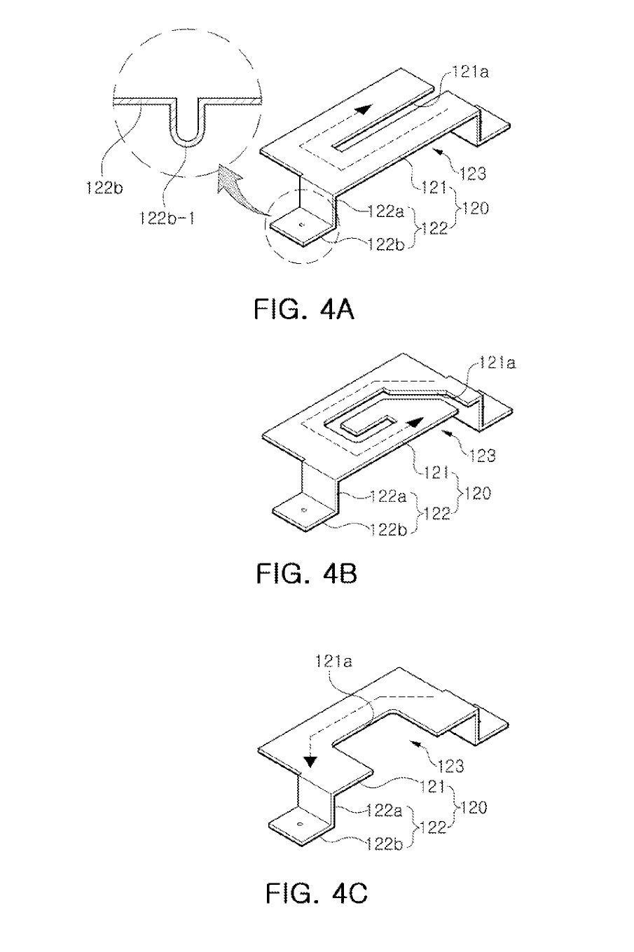

FIGS. 3A through 3C are cross-sectional views taken along line A-A′ of FIG. 1 according to various alternative examples, and FIGS. 4A through 4C are perspective views of a metal frame 120 according to various alternative examples.

Referring to FIGS. 3A through 3C and 4A through 4C, the antenna module 100 includes a circuit board 110, the metal frame 120, and a molding frame 130.

At least one electronic element (not illustrated) required to drive the electronic device 500 is mounted on the circuit board 110. To this end, mounting electrodes, a wiring pattern connecting the mounting electrodes to each other, and a ground electrode may be formed. In addition, the circuit board 110 may be provided as a printed circuit board (PCB) or a flexible printed circuit board (FPCB) made of polyethylene terephthalate (PET), glass, polycarbonate (PC), silicon (Si), or the like.

As shown in FIGS. 3A through 3C, the circuit board 110 includes a connector 111 for charging the electronic device 500 and transmitting or receiving data. In detail, the connector 111 may be connected to a separated data cable and serves to charge a battery (not illustrated) included in the electronic device 500. In addition, the connector 111 may be connected to a data device such as a computer, a multimedia device, or the like, to transmit information stored in the electronic device 500 to the data device and transmit information stored in the data device to the electronic device 500.

The connector 111 may be fixed to the circuit board 110 using a soldering process, and the soldering process may be performed using a surface-mounting device (SMD) technology. Surface-mounting device (SMD) technology refers to a technology that allows the connector 111 and the circuit board 110 to be soldered to each other by interposing solder paste between the circuit board 110 and the connector 111, and then applying heat to melt the solder paste.

The connector 111 is apt to be broken due to external shock such that the connector 111 becomes separated from the circuit board 110. However, the antenna module 100 includes the metal frame 120 disposed above the connector 111, thereby protecting the connector 111 from external shock and preventing the connector 111 from being separated from the circuit board 110. The metal frame 120 may be made, for example, of a conductive metal such as aluminum, copper, or the like.

As shown in FIGS. 3A through 3C, the circuit board 110 includes a terminal 112 for establishing electrical contact with the metal frame 120. More specifically, the metal frame 120 is in contact with the terminal 112 of the circuit board 110, thereby performing an antenna function.

The metal frame 120 is included in the electronic device 500 to serve as an antenna and protect the connector 111. As shown in FIGS. 4A-4C, the metal frame 120 includes an antenna pattern part 121 that transmits or receives a signal, and a connection terminal part 122 that connects the antenna pattern part 121 and the circuit board 110 to each other.

The metal frame 120 receives an external signal and transfers the external signal to a signal processing device of the electronic device 500, or receives an internally generated signal generated by the electronic device 500 and externally transmits the internally generated signal. To this end, the antenna pattern part 121 may be formed in a meander-line structure. In addition, the connection terminal part 122, which is in contact with the circuit board 110, transmits the received external signal to the electronic device 500 or receives the internally generated signal generated by the electronic device 500.

The metal frame 120 may be formed in a three-dimensional structure by bending the antenna pattern part 121 and the connection terminal part 122, respectively. The antenna pattern part 121 serves as the antenna transmitting or receiving the signal to or from the electronic device 500, and may include at least one slit 121a in order to improve performance efficiency of the antenna.

As shown in FIGS. 4A through 4C, the slit 121a may be formed in various shapes in the antenna pattern part 121.

In detail, the slit 121a may be formed in a straight line in the antenna pattern part 121 (see FIG. 4A), may be formed so as to have at least one bend (see FIG. 4B), or may be formed so as to be recessed in a rectangular shape on one side of the antenna pattern part 121 (see FIG. 4C). However, the shape of the slit 121a is not limited to the examples specifically provided herein, and may be changed in a number of ways. Additionally, the type of antenna provided in the antenna module 100 may be determined by a structure of the slit 121a.

In detail, depending on a shape of the slit 121a, the antenna module 100 may function as a monopole antenna, a planar inverted-F antenna (PIFA), a loop antenna, or the like.

The connection terminal part 122 is bent with respect to the antenna pattern part 121 so as to be in contact with the terminal 112 of the circuit board 110, and the connection terminal part 122 is connected to the terminal 112 of the circuit board 110 such that antenna performance of the metal frame 120 may be implemented in the electronic device 500.

The connection terminal part 122 is bent to extend from two opposing sides of the antenna pattern part 121. In this case, the antenna pattern part 121 is provided above the connector 111 described above, and the connection terminal part 122 is bent with respect to the antenna pattern part 121 toward the connector 111.

In detail, the connection terminal part 122 includes a connection part 122a that is provided on each of the two opposing sides of the antenna pattern part 121, and is bent in toward the connector 111. The connection terminal part 122 also includes a contact part 122b extending from and bent with respect to the connection part 122a at each of the two opposing sides of the antenna pattern part 121 to be in contact with the circuit board 110.

Thus, the antenna pattern part 121 and the connection terminal part 122 have a predetermined space 123 formed inside thereof, and the connector 111 is disposed inside the space 123.

As a result, according to an example, since the connector 111 is surrounded by the antenna pattern part 121, the connection terminal part 122, and the circuit board 110, damage to the connector 111 by external shock may be prevented.

Further, by disposing the metal frame 120 to surround an outer side of the connector 111, an area in the electronic device 500 occupied by the metal frame 120 (a component implementing an antenna function in the examples disclosed herein) may be significantly reduced.

The connection terminal part 122 is connected to the terminal 112 of the circuit board 110 so as to transmit and receive a signal, and, in order to provide reliability of signal transmission, the connection terminal part 122 may be in elastic contact with the circuit board 110. To this end, a component for securing elastic force may be added to the connection terminal part 122. In detail, the contact part 122b of the connection terminal part 122 may include a reinforcement part 122b-1, as shown in FIG. 4A.

The reinforcement part 122b-1 may be formed by compressing the contact part 122b so that the reinforcement part 122b-1 protrudes from one surface of the contact part 122b toward the terminal 112. Here, the reinforcement part 122b-1 may have a bead shape formed so as to protrude from the contact part 122b, or may be formed by bending the entire contact part 122b to protrude from the connection part 122a toward the terminal 112.

The molding frame 130 may be manufactured by injection molding the molding frame 130 so that the connection terminal part 122 of the metal frame 120 is exposed to one surface of the molding frame 130. In detail, the metal frame 120 may be fixed to the molding frame 130 by injection-molding the molding frame 130 around the metal frame 120, and may thereafter be coupled to the electronic device 500.

In this case, the connection terminal part 122 may be exposed to one surface of the molding frame 130 facing the circuit board 110, and, in order to secure elastic force of the connection terminal part 122, when the injection molding process is completed, the connection terminal part 122 may be rotatably bent so as to be spaced apart from the molding frame 130. By doing so, the metal frame 120 is provided as an elastic body, and thus, the connection terminal part 122 may naturally have elasticity. Since other structures provided to reinforce the elastic force have been described above in detail, a description thereof will be omitted.

The molding frame 130 may be an injection-molded structure. In this case, the connection terminal part 122 may be exposed to one surface of the molding frame 130, but a position of the antenna pattern part 121 may be variously changed as illustrated in FIGS. 3A through 3C.

In detail, referring to FIG. 3A, the antenna pattern part 121 may be exposed to one surface (e.g., the inner surface) of the molding frame 130 so as to face the connector 111.

Alternatively, as shown in FIG. 3B, the antenna pattern part 121 may be injection-molded so as to be provided inside the molding frame 130. In this case, a portion of the molding frame 130 may be interposed between the connector 111 and the antenna pattern part 121.

Alternatively, as shown in FIG. 3C, the antenna pattern part 121 may be injection-molded so as to be exposed to the other surface (e.g., the outer surface) of the molding frame 130 opposite to the one surface of the molding frame 130 to which the connection terminal part 122 is exposed. In this case, an exposed outer surface of the antenna pattern part 121 may be covered with a film, or the like. The film may be immediately formed by spraying a liquid through a coating process, a painting process, or the like, or may be formed by applying manufactured goods such as a film, a coating, or the like.

In a state in which the antenna pattern part 121 is covered with the rear cover 12, the antenna pattern part 121 may not be externally exposed, and thus, no problems occur. However, when the rear cover 12 is opened in order to replace a battery, or the like, the antenna pattern part 121 is externally exposed. Thus, the exposed outer surface of the antenna pattern part 121 may be additionally covered with the film considering appearance thereof when the rear cover 12 is opened.

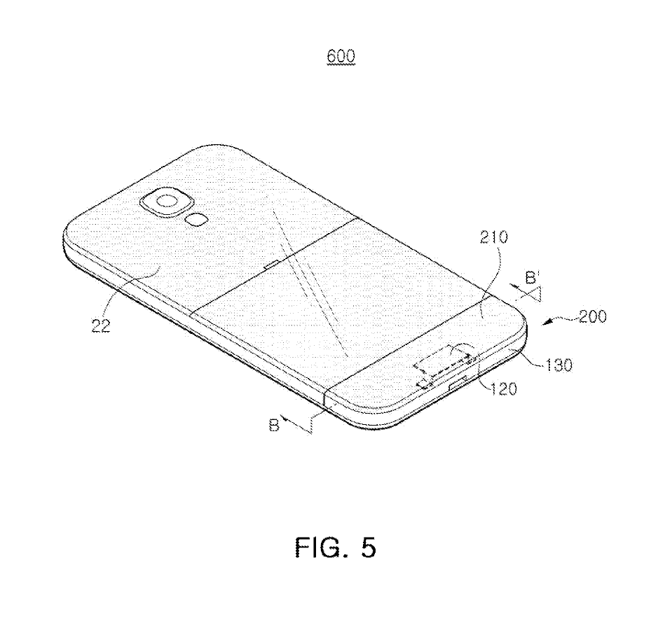

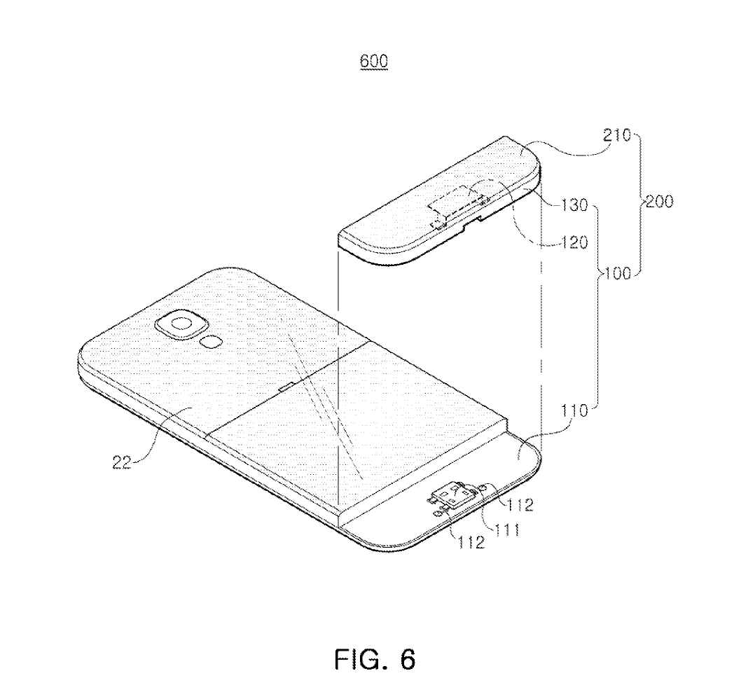

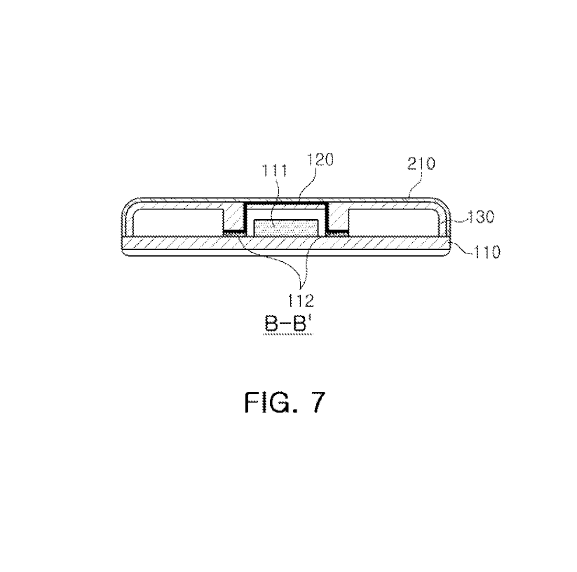

FIG. 5 is a perspective view of an electronic device 600 including an antenna assembly 200 according to another example, and FIG. 6 is an exploded perspective view of the electronic device 600. FIG. 7 is a cross-sectional view taken along line B-B′ of FIG. 5.

Referring to FIGS. 5 through 7, the antenna assembly 200 includes an antenna module 100 and a cover frame 210. Here, the antenna module 100 may have substantially the same configuration as a configuration of the antenna module 100 described with reference to FIGS. 1 through 4. Accordingly, a detailed description of the antenna module 100 will be omitted in the following discussion.

The antenna assembly 200 may be manufactured by additionally injection molding the antenna module 100 according to the examples illustrated in FIGS. 1 through 4.

In detail, the antenna module 100 may be manufactured only by a primary molding process, but the antenna assembly 200 may be manufactured by secondarily injection molding the antenna module 100 manufactured by the primary molding process.

Accordingly, the cover frame 210, which is a secondary injection-molded product forming part of a case 22, may be provided to an outer side of the antenna assembly 200, and thus, a separate case may not need to be provided when the antenna assembly 200 is assembled with the electronic device 600.

A configuration of the antenna assembly 200 will be described. The cover frame 210 may be injection-molded so as to cover one surface of the antenna module 100, and the antenna pattern part 121 may be embedded between the molding frame 130 and the cover frame 210.

In addition, when the antenna assembly 200 is coupled to the electronic device 600, the cover frame 210 may be disposed at the outermost portion to form a portion of the case 22.

Further, an example electronic device as described herein may include a mobile phone, a smartphone, a laptop computer, a digital broadcasting terminal, a personal digital assistant (PDA), a portable multimedia player (PMP), an E-book, a navigation system, and the like.

As set forth above, according to examples disclosed herein, an antenna module and an electronic device including the same may significantly reduce the space in which an antenna is mounted as well as protect a connector for charging the electronic device and for transmitting and receiving data.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An antenna module comprising:
a circuit board comprising a connector;
a metal frame comprising an antenna pattern part configured to transmit or receive a signal, and a connection terminal part electrically connecting the antenna pattern part and the circuit board to each other; and
a molding frame disposed around the metal frame such that the connection terminal part is exposed to one surface of the molding frame,
wherein the connector is disposed between the metal frame and the circuit board.

2. The antenna module of claim 1, wherein the antenna pattern part is disposed on an inner side of the molding frame, and the connection terminal part is exposed to one surface of the molding frame facing the circuit board.

3. The antenna module of claim 1, wherein the antenna pattern part is disposed above the connector, and the connection terminal part is bent with respect to the antenna pattern part toward the connector.

4. The antenna module of claim 3, wherein the connector is disposed inside a space formed by the antenna pattern part and the connection terminal part.

5. The antenna module of claim 1, wherein the antenna pattern part includes a slit.

6. The antenna module of claim 5, wherein the slit comprises at least one bend.

7. The antenna module of claim 1, wherein the antenna pattern part is exposed to an other surface of the molding frame opposite to the one surface of the molding frame to which the connection terminal part is exposed.

8. The antenna module of claim 7, comprising a protective film disposed on the other surface of the molding frame and the connection terminal part.

9. An antenna assembly comprising:
an antenna module including
a metal frame including an antenna pattern part and being electrically connected to a circuit board including a connector so as to transmit a signal to the circuit board or receive a signal from the circuit board, and
a molding frame disposed around the metal frame; and
a cover frame covering an upper outer surface of the antenna module,
wherein the connector is disposed between the metal frame and the circuit board, and the antenna pattern part is disposed between the molding frame and the cover frame.

10. The antenna assembly of claim 9, wherein the metal frame comprises a connection terminal part bent with respect to the antenna pattern part toward the connector.

11. The antenna assembly of claim 10, wherein the connector is disposed inside a space formed by the antenna pattern part and the connection terminal part.

12. The antenna assembly of claim 9, wherein the antenna pattern part includes a slit.

13. The antenna assembly of claim 9, wherein the cover frame forms a portion of a case of a mobile communications terminal.

14. An antenna module comprising:
a circuit board comprising a connector;
a metal frame comprising an antenna pattern part configured to transmit or receive a signal, and a connection terminal part electrically connecting the antenna pattern part and the circuit board to each other; and
a molding frame disposed around the metal frame,
wherein the connector is disposed between the metal frame and the circuit board, and
wherein the connection terminal part comprises a reinforcement part protruding from a contact part of the connection terminal part and elastically contacting the circuit board.

15. The antenna module of claim 14, wherein the reinforcement part is bead-shaped.

16. The antenna module of claim 14, wherein the connector is configured to enable charging of the electronic device, and transmitting and receiving data.
